(19) United States
(12) Patent Application Publication
(10) Pub. No.: US 2009/0185389 A1
(43) Pub. Date: Jul. 23, 2009

(54) Light guide for a lamp

(75) Inventors: Thomas Tessnow, Weare, NH (US); Hong Luo, Danvers, MA (US)

Correspondence Address: OSRAM SYLVANIA INC, 100 ENDICOTT STREET, DANVERS, MA, 01923, US

(73) Assignee: OSRAM SYLVANIA INC, DANVERS, MA (US)

(21) Appl. No.: 12/231,838

(22) Filed: Sep. 5, 2008

Related U.S. Application Data
(60) Provisional application No. 61/011,773, filed on Jan. 18, 2008.

(51) Int. Cl. F21V 7/00

(52) U.S. Cl. 362/516

(57) ABSTRACT

A light with one or more LEDs directing light in a first direction. The light has first and second over-lying light guides receiving light from the LEDs. The light guides extend in the first direction X. Plural LEDs can be used and they may direct light from either or both ends of the light guides. The light guides can be clear if the LEDs emit colored light, or colored if the LED emits white light. A plurality of first light deflectors is associated with the first light guide and a plurality of second light deflectors is associated with the second light guide for directing the light that has been emitted from the light source along the first direction X in a second, output direction Y, the first light deflectors being offset from the second light deflectors to evenly distribute output light.

### CROSS-REFERENCE TO RELATED APPLICATION

This application claims priority from Provisional Patent Application titled “LIGHT GUIDE FOR A LAMP” Ser. No. 61/011,773, filed Jan. 18, 2008.

### TECHNICAL FIELD

This invention relates to electric lamps and particularly to electric lamps with light guide elements. More particularly the invention relates to an arrangement of light guides each having deflectors coordinated to form a combined supplemental pattern. While applicable to many situations, the lamp is well suited for the stop/turn/tail light function in a motor vehicle.

### BACKGROUND ART

Light guide optics with flexible optical fibers or rigid light guides are known in the art. Typically, these light guides employ a single layer of optic and the front and back sides of this optic include features to redirect the light entering the light guide from a light source in a manner that is perpendicular to an axis of the light guide. The density of these features will determine the homogeneity of the illuminated appearance. To achieve a smoother appearance, a high number of small-sized features is used. However, the high density thus created prevents the light from traveling very far along the light guide. This problem is particularly prevalent in higher modes or in cases where it is necessary or desired to bend the light guide. Such cases require total internal reflection in order to guide the light and, to achieve total or near total reflection, straight sections of guide are required between the optical surface features. In order to have long light guides it is necessary to provide straight, or near straight, sections as well as optical features such as light deflectors to redirect the light and these two items must be balanced.

### DISCLOSURE OF INVENTION

It is, therefore, an object of the invention to obviate the disadvantages of the prior art.

It is another object of the invention to enhance lights and light emission therefrom.

It is yet another object of the invention to improve lights and light emission therefrom.

These objects are accomplished, in one aspect of the invention, by the provision of a light comprising: a light source directing light in a first direction; first and second over-lying light guides for receiving light from said light source, said light guides extending in said first direction; and a plurality of first light deflectors associated with said first light guide and a plurality of second light deflectors associated with said second light guide for directing light emitted from said light source along said first direction in a second direction, said first light deflectors being offset from the second light deflectors.

The use of multiple guides, each with deflectors that are offset one from the other allows for a desired increase in the number and location of deflectors without undue interruption in the passage of the light.

### BRIEF DESCRIPTION OF THE DRAWINGS

FIG. 1 is a diagrammatic elevation view of an embodiment of the invention;

FIG. 2 is a similar view of an alternate embodiment of the invention;

FIG. 3 is a similar view of yet another embodiment of the invention;

FIG. 4 is similar view of still another embodiment of the invention;

FIG. 5 is a similar view of an alternate embodiment of the invention employed as a vehicle light; and

FIG. 6 is a similar diagrammatic view of an alternate embodiment of deflectors.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

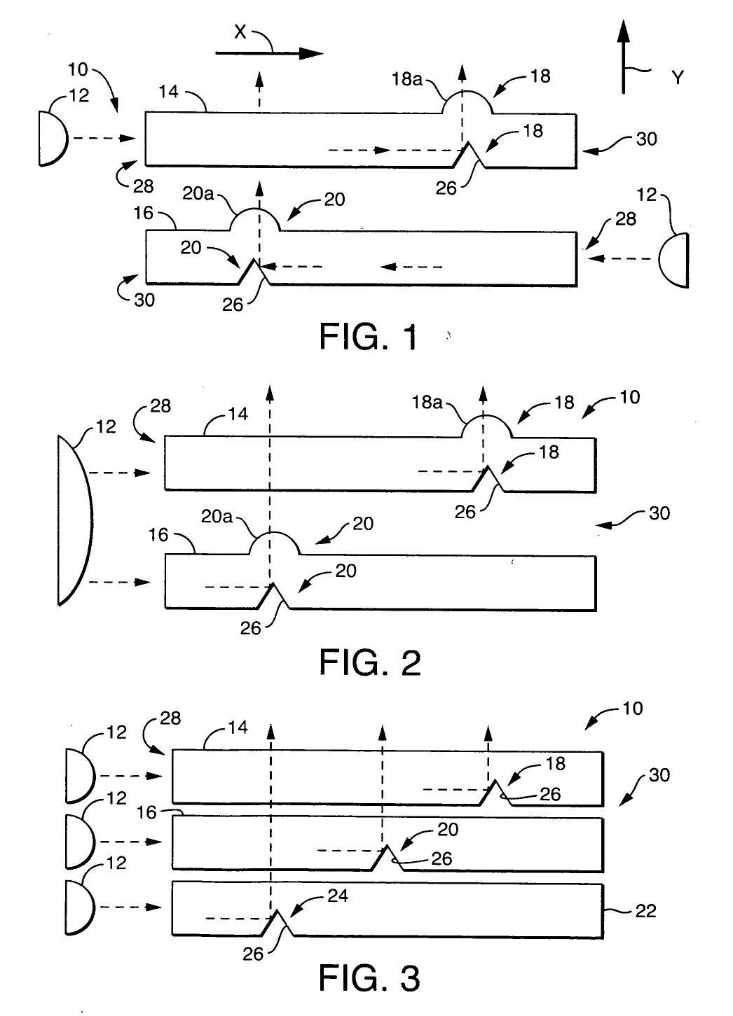

Referring now to the drawings with greater particularity, there is shown in FIG. 1 a light 10 comprising a light source 12, which preferably comprises one or more light emitting diodes (LED or LEDs) directing light (indicated by dashed-lines) in a first direction X. The light 10 has first and second over-lying light guides 14, 16 for receiving light from the light source 12 and the light guides 14, 16 extend in the first direction X. As shown in FIG. 1, plural light sources 12 can be employed and they may direct light from either or both ends of the light guides. The light guides can be clear if the light source or sources 12 emit colored light, or colored (for example, red, in the event the light 10 is used as a tail light for a vehicle) if the light source emits white light.

A plurality of first light deflectors 18 is associated with the first light guide 14 and a plurality of second light deflectors 20 is associated with the second light guide 16 for directing the light that has been emitted from the light source 12 along the first direction X in a second, output direction Y, the first light deflectors 18 being offset from the second light deflectors 20 so as to even out the distribution of the output light.

The deflectors 18 and 20 can comprises protrusions 18a, 20a or internal grooves 26; however, the grooves 26 are preferred. In any event, the deflectors are formed to extend laterally to the first direction X.

FIGS. 1 and 2 illustrate embodiments where two light guides, 14 and 16 are used. The concept is easily adaptable to more than two guides as is shown in FIGS. 3, 4 and 5, wherein a third light guide 22 is added, it being understood that the space between the light guides should be as small as practical to limit light loss between the multiple light guides.

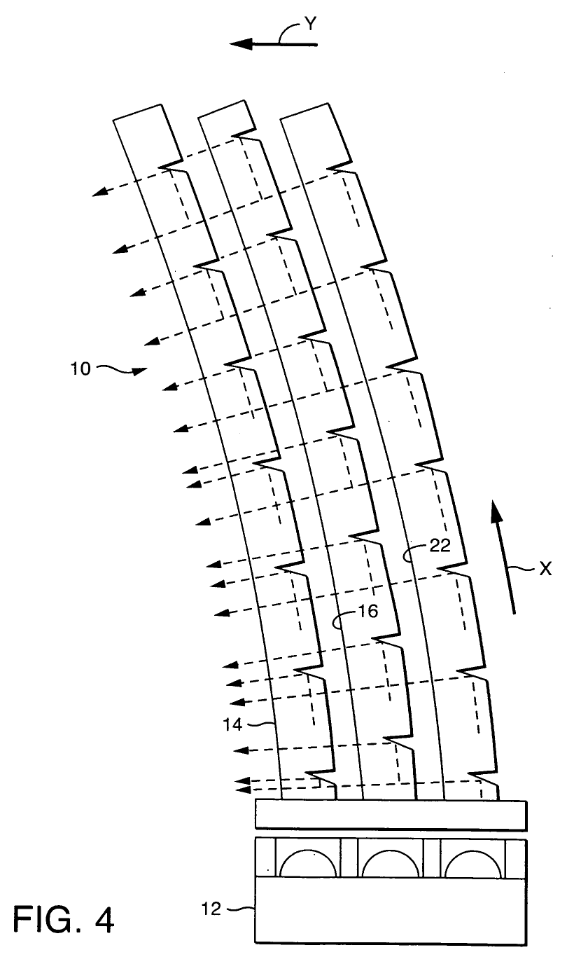

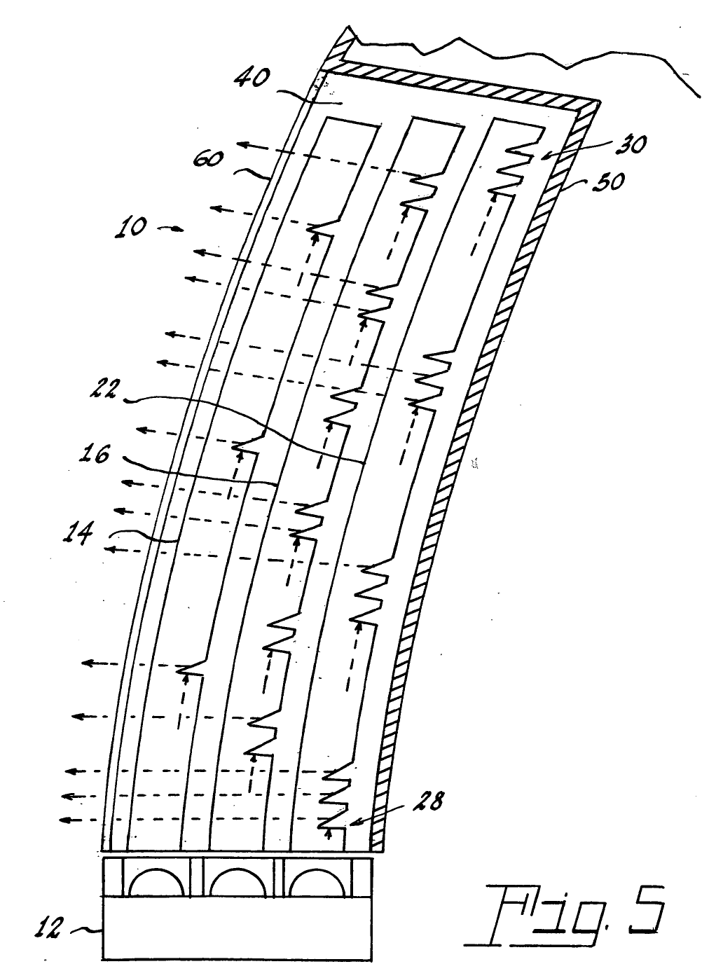

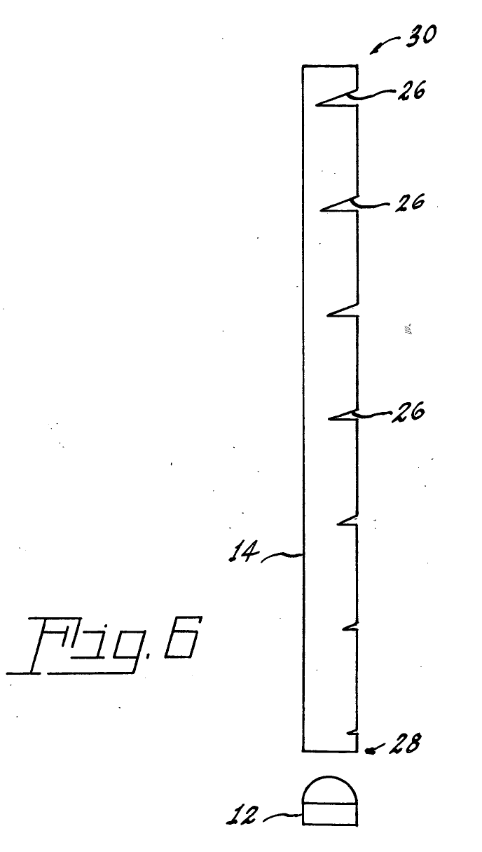

Additionally, great variation in the number and placement of the deflectors is possible. For example, as shown in FIGS. 1-4, each light guide 14, 16, (and 22 in FIGS. 3 and 4) is provided with single, but offset deflectors 18, 20, and 24 in the form of grooves 26. An alternate arrangement is shown in FIG. 5 wherein the light guide 14 is provided with single deflectors 18, the second light guide 16 comprises double deflectors 20 and the third light guide 22 has a plurality of third light deflectors 24 associated therewith, the third deflectors 24 comprising triple deflectors.

The light guides have a proximal end 28 adjacent the light source 12 and a distal end 30 remote from the light source 12 and, in a preferred embodiment, the grooves 26 increase in deflecting intensity progressively from the proximal end to the distal end. The increase in deflecting intensity can be accomplished by making the grooves progressively larger or deeper as they approach the distal end, as is shown in FIG. 6.

The light 10 can be planar in form, as shown in FIGS. 1-3, convex as shown in FIG. 4 or concave as shown in FIG. 5. The latter embodiment illustrates the light 10 assembled in an indentation 40 formed in a vehicle body 50 and covered by a light-transmitting panel 60. In this instance the light 10 can function as the stop/tail/turn indicator.

While the light source 12 can take many forms, in the preferred embodiments of the invention the light source 12 is a light emitting diode, for example, a type known as L2200R, available from Osram Sylvania. This particular source has 6 LEDs and is formed with internal optics to provide a ±30 degree emission pattern.

The light thus provided is capable of directing light in a second direction from a first direction by employing multiple deflectors in a manner to achieve a high density without causing obfuscation of the emitted light.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A light comprising:
a light source directing light in a first direction:
first and second over-lying light guides for receiving light from the light source, the light guides extending in the first direction;
a plurality of first light deflectors associated with the first light guide and a plurality of second light deflectors associated with the second light guide for directing light emitted from the light source along the first direction in a second direction, the first light deflectors being offset from the second light deflectors.

2. The light of claim 1 wherein the first and second light deflectors are formed internally of the light guides.

3. The light of claim 1 wherein the first deflectors of the first light guide comprise single deflectors and the second deflectors of the second light guide comprise double deflectors.

4. The light of claim 3 wherein a third light guide over-lies the second light guide, the third light guide having a plurality of third deflectors associated therewith, the third deflectors comprising triple deflectors.

5. The light of claim 1 wherein the light deflectors are formed as grooves within the light guides, the grooves extending laterally to the first direction.

6. The light of claim 1 wherein the first and second over-lying light guides have a proximal end adjacent the light source and a distal end remote from the light source.

7. The light of claim 6 wherein the light deflectors are formed as grooves within the light guides, the grooves extending laterally to the first direction.

8. The light of claim 7 wherein the grooves increase in deflecting intensity progressively from the proximal end to the distal end.

9. The light of claim 8 wherein the light sources comprises a plurality of light emitting diodes.

10. The light of claim 9 wherein the light comprises a vehicle light.
